(19) United States
(12) Patent Application Publication
(10) Pub. No.: US 2003/0050774 A1
(43) Pub. Date: Mar. 13, 2003

(54) Method and system for phonetic recognition

(75) Inventor: Chia Chi Feng, S/N EDF Zhi Kuan (MO)

Correspondence Address: ROTHWELL, FIGG, ERNST & MANBECK, P.C., 1425 K STREET, N.W., SUITE 800, WASHINGTON, DC, 20005, US

(73) Assignee: Culturecom Technology (Macau), Ltd.

(21) Appl. No.: 09/940,651

(22) Filed: Aug. 29, 2001

(51) Int. Cl. G10L 19/14; G10L 21/00

(52) U.S. Cl. 704/205

(57) ABSTRACT

A method and a system for phonetic recognition are proposed, in which phonetic recognition is implemented by using principles of phonetic recognition, and a general database of phonetic sounds and corresponding characters, so as to recognize a phonetic sound generated by a user and identify a character corresponding to the user's phonetic sound, without requiring a personal database of phonetic sounds and corresponding characters for the user to be establish in advance. Moreover, the method and system for phonetic recognition can also recognize a tone of the phonetic sound to be able to identify a Chinese character corresponding in variation of four tones to the phonetic sound. In addition, in the method and system for phonetic recognition, the phonetic sound can be analyzed in timbre characteristic for allowing the user's timbre to be recognized, while variation in volume of the phonetic sound can be analyzed so as to tell the user's emotional condition.

### FIELD OF THE INVENTION

The present invention relates to methods and systems for phonetic recognition, and more particularly, to a method and a system for phonetic recognition, in which principles of phonetic recognition and a general database of phonetic sounds and corresponding characters are employed so as to analyze a phonetic waveform for phonetic recognition, without the pre-construction of a database of personal phonetic sounds and corresponding characters.

### BACKGROUND OF THE INVENTION

In general, a conventional method and a system for phonetic recognition are performed in a sampling manner that a sound waveform corresponding to a phonetic packet of a user is sectionally sampled, and characteristics such as frequency, amplitude waveform and carrier waveform of each sampled section of the phonetic packet are stored in a database in advance. This then allows the user to perform personal phonetic comparison and recognition. In other words, prior to using the conventional method and system for phonetic recognition, it is necessary to construct a personal database containing massive data of phonetic sounds and corresponding characters for the user, and thus phonetic recognition can not be simply conducted by using principles of phonetic recognition and a general database of phonetic sounds and corresponding characters.

The conventional technology has the following drawbacks. In the case of performing the phonetic recognition by different users, a respective personal database needs to be built up for each of the users, due to differences in sound frequency, amplitude waveform and carrier waveform even for the same character in response to regional accents of the users. This therefore can not employ the principles of phonetic recognition and the general database of phonetic sounds and corresponding characters for performing the phonetic recognition, and also the built-up personal base is usually huge, which increases difficulty in conducting the phonetic recognition. Furthermore, the conventional method and system for phonetic recognition can neither tell a difference in timbre between the users and nor recognize the user's emotion state. Moreover, as a personal database of phonetic sounds and corresponding characters needs to be established for each user prior to using the conventional method and system, phonetic recognition can not be implemented by a user who is in first time to access the conventional method and system, due to no personal database constructed for the user.

Therefore, it is desired to develop a method and a system for phonetic recognition that do not require a personal database of phonetic sounds and corresponding characters to be established for a user in advance. Contrarily, the phonetic recognition is implemented by using general principles of phonetic recognition and a general database of phonetic sends and corresponding characters, and applicable for users with different accents, so as to identify a character corresponding to a phonetic sound generated from the user, tell the difference in timbre between the users and recognize the user's emotional state.

### SUMMARY OF THE INVENTION

A primary objective of the present invention is to provide with a method and a system for phonetic recognition, in which phonetic recognition is implemented by using principles of phonetic recognition and a general database of phonetic sounds and corresponding characters, so as to recognize a phonetic so generated by a user and identify a character corresponding to the user's phonetic sound, without requiring a person database of phonetic sounds and corresponding characters for the user to be establish in advance. Moreover, the method and system for phonetic recognition can also recognize a tone of the phonetic sound to be able to identify a Chinese character corresponding in variation of four tones to the phonetic sound. In addition, in the method and system for phonetic recognition, the phonetic sound can be analyzed in timbre characteristic for allowing the user's timbre to be recognized, while variation in volume of the phonetic sound can be analyzed so as to tell the user's emotional condition.

According to the foregoing and other objectives, the present invention proposes a method and a system for phonetic recognition, in which phonetic recognition is conducted by using principles of phonetic recognition and a general database of phonetic sounds and corresponding characters, without requiring a database of personal phonetic sounds and corresponding characters.

The method for phonetic recognition comprises the steps of processing a phonetic sound generated by a user and transforming the phonetic sound into a phonetic waveform; analyzing physical properties of the phonetic waveform for acquiring characteristic parameters of the waveform, and determining a fore frequency and a rear frequency of the sound packet; dividing a sound packet of the phonetic waveform into parts of consonant, wind and vowel, according to the characteristic parameters; analyzing the parts of consonant and vowel for waveform characteristics thereof so as to recognize a character consonant corresponding to the part of consonant and a character vowel corresponding to the part of vowel, and recognizing a tone for the phonetic sound according to a rule for determining the fore and rear frequencies; combining the recognized parts of consonant and vowel and the recognized tone for determining a corresponding character for the phonetic sound; and completing the phonetic recognition.

The system for phonetic recognition of the invention comprises a phonetic recognition principle database, a database of phonetic sounds and corresponding characters, a phonetic transformation processing module and a phonetic recognition processing module.

The phonetic recognition principle database includes principles of phonetic recognition to be used for processing a sound packet of a phonetic sound and dividing the sound packet into parts of consonant, wind and vowel, and determining a fore frequency and a rear frequency for the sound packet, so as to recognize the parts respectively, recognize a tone for the phonetic sound according to rules for determining the fore and rear frequencies, and combine the recognized parts of consonant and vowel or the recognized parts of consonant and vowel together with the recognized tone to be compared with a database of phonetic sounds and corresponding characters for obtaining a corresponding character for the phonetic sound.

The principles of phonetic recognition in the phonetic recognition principle database include a rule for dividing the sound packet into the parts of consonant, wind and vowel; a rule for determining the fore and rear frequencies; a rule for recognizing the parts of consonant, wind and vowel; a rule for recognizing the tone for the phonetic sound a rule for combining the recognized parts of consonant and vowel; and a rule for combining the recognized parts of consonant and vowel and the recognized tone.

The database of phonetic sound and corresponding characters has a phonetic sound therein consisting of a consonant and a vowel, or a consonant, a vowel and a tone, and a corresponding character for each phonetic sound.

The phonetic transformation processing module is used for transforming a user's phonetic sound into a corresponding physical waveform signal and inputting the waveform signal to a phonetic recognition processing module for phonetic recognition.

The phonetic recognition processing module, according to the principles of phonetic recognition in the phonetic recognition principle database, processes the waveform signal by dividing a sound packet thereof into parts of consonant, wind and vowel, and determining a fore frequency and a rear frequency for the sound packet, so as to recognize the parts respectively, recognize a tone for the phonetic sound according to a rule for determining the fore and rear frequencies, and combine the recognized parts of consonant and vowel or the recognize pats of consonant and vowel together with the recognized tone to be compared with the database of phonetic sounds and corresponding characters for obtaining a corresponding character for the phonetic sound.

### BRIEF DESCRIPTION OF THE DRAWINGS

The present invention may best be understood through the following description with reference to the accompanying drawings, in which:

FIG. 1 is a block diagram of basic system architecture of the method and system for phonetic recognition of the invention;

FIG. 2 is a schematic diagram showing the steps involved in performing the method for phonetic recognition in the use of the system for phonetic recognition of the invention in FIG. 1;

FIG. 3 is a schematic diagram showing the steps involved in performing the method for phonetic recognition so as to recognize a phonetic sound, timbre and emotional condition in the use of the system for phonetic recognition of the invention in FIG. 1;

FIG. 4 is a schematic diagram showing the detail steps involved in performing the method for phonetic recognition in the use of the system for phonetic recognition of the invention in FIG. 2;

FIG. 5 is a schematic diagram showing the detail steps involved in performing the method for phonetic recognition so as to recognize a phonetic sound, timbre and emotional condition in the use of the system for phonetic recognition of the invention in FIG. 3;

FIG. 6 is a schematic diagram showing the detail steps involved in recognizing a Chinese character correspond to a phonetic sound in the use of the system for phonetic recognition of the invention in FIG. 4;

FIG. 7(a) is a schematic diagram showing composition of a phonetic waveform;

FIG. 7(b) is a schematic diagram showing parts of consonant, wind and vowel;

FIG. 7(c) is a schematic diagram showing a plosive waveform in the consonant part of FIG. 7(b);

FIG. 7(d) is a schematic diagram showing an affricate waveform in the consonant part of FIG. 7(b);

FIG. 8 is a schematic diagram showing composition of the vowel part in FIG. 7(b)

FIG. 9 is a schematic diagram showing characteristic parameters of the composition of the vowel part in FIG. 7(b);

FIG. 10 is a schematic diagram showing statistic frequencies for four tones of Chinese characters; and

FIG. 11 is a schematic diagram showing a waveform of consonant and vowel for a Chinese character “ [symbol] ” for phonetic recognition.

### DETAILED DESCRIPTION OF PREFERRED EMBODIMENTS

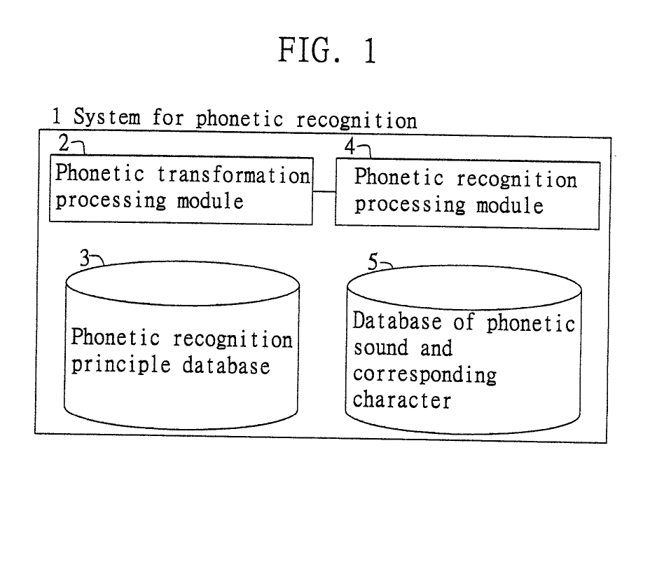

FIG. 1 illustrates basic system architecture of the method and system for phonetic recognition of the invention. As shown in the drawing, the system for phonetic recognition 1 of the present invention includes a phonetic transformation processing module 2, a phonetic recognition principle database 3, a phonetic recognition processing module 4 and a general database of phonetic sounds and corresponding characters 5. The phonetic transformation prosing module 2 can be an electronic device for transforming a phonetic sound into an electronic signal. The phonetic recognition processing module 4 is a computer mainframe. The phonetic recognition principle database 3 and the general database of phonetic sounds and corresponding characters 5 are stored in a memory device of the computer.

The phonetic recognition principle database 3 contains principles of phonetic recognition, which include a rule for dividing a sound packet of the phonetic sound into parts of consonant, wind and vowel; a rule for extracting fore and rear frequencies of the sound packet, a rule for identifying consonant, wind and vowel; a rule for recognizing variation in four tones; a rule for combining consonant and vowel; a rule for combining consonant, vowel and four tones; a rule for recognizing timbre of the sound packet; and a rule for recognizing volume variation of the sound pet. The principles of phonetic recognition are used to divide the sound packet into the parts of consonant, wind and vowel for identification. The extracted fore and rear frequencies of the sound packet, together with frequencies of the vowel part and profile variation in waveform amplitude, are used to recognize the variation in four tones for a Chinese phonetic sound. Combinations of the identified parts of consonants and vowels, or combinations of consonants, vowels and four tone variations are compared with the database of phonetic sounds and corresponding characters 5, so as to obtain a character corresponding to the phonetic sound.

The general database of phonetic sounds and corresponding characters 5 contains a character database corresponding to phonetic sounds. A phonetic so is a combination of a consonant and a vowel, or a combination of a consonant, a vowel and one of four tone variations. Each phonetic sound has its own corresponding word.

The phonetic transformation processing module 2 is used to transform a user's phonetic sound correspondingly into a physical waveform signal, and input the signal to the phonetic recognition processing module 4 for phonetic recognition.

According to the principles of phonetic recognition in the phonetic recognition principle database 3, the phonetic recognition processing module 4 processes the waveform signal by dividing it into the parts of consonant, wind and vowel, and extracting its fore and rear frequencies, so as to identify, process and combine the parts of consonant, wind and vowel. Combinations of the identified parts of consonants and vowels, or combinations of consonants, vowels and four tone variations are compared by the phonetic recognition processing module 4 with the database of phonetic sounds and corresponding characters 5, so as to obtain the corresponding character for the phonetic sound.

In order to identify the timbre of the user, the phonetic recognition processing module 4, according to the principles of phonetic recognition in the phonetic recognition principle database 3, analyzes the sound packet for its carrier wave and edges of modulated saw wave on the carrier wave, so as to obtain the timbre characteristics and differentiate the timbre users. In order to recognize the user's emotional condition, the phonetic recognition processing module 4 analyzes the volume variation in the sound packet, which correlates with intonation and reflects the user's emotion, according to the principles of phonetic recognition in the phonetic recognition principle database 3.

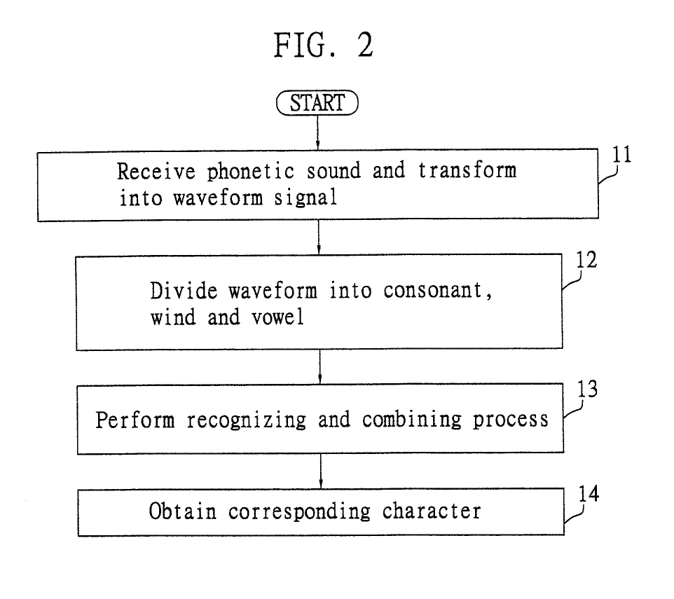

FIG. 2 illustrates the steps involved in performing the method for phonetic recognition in the use of the system for phonetic recognition of the invention in FIG. 1. As shown in the drawing, in step 11, the phonetic transformation processing module 2 receives a phonetic sound from a user and transforms it correspondingly into a physical waveform signal, which is input to the phonetic recognition processing module 4 for phonetic recognition. Then, step 12 is followed.

In step 12, according to principles of phonetic recognition in the phonetic recognition principle database 3, the phonetic recognition processing module 4 processes the input waveform signal from the phonetic transformation processing module 2 by dividing a sound packet of the input waveform signal into parts of consonant, wind and vowel, and extracting its fore frequencies and rear frequencies. Then, step 13 is followed.

In step 13, the phonetic recognition processing module 4 recognizes, processes and combines the parts of consonant, wind and vowel, so as to combine the recognized parts of consonant and vowel, or the parts of consonant and vowel and four tone variations. Then, step 14 is followed.

In step 14, the phonetic recognition processing module 4 compares the combinations with the general database of phonetic sounds and corresponding characters 5 so as to obtain a corresponding character for the phonetic sound, and the phonetic recognition completes.

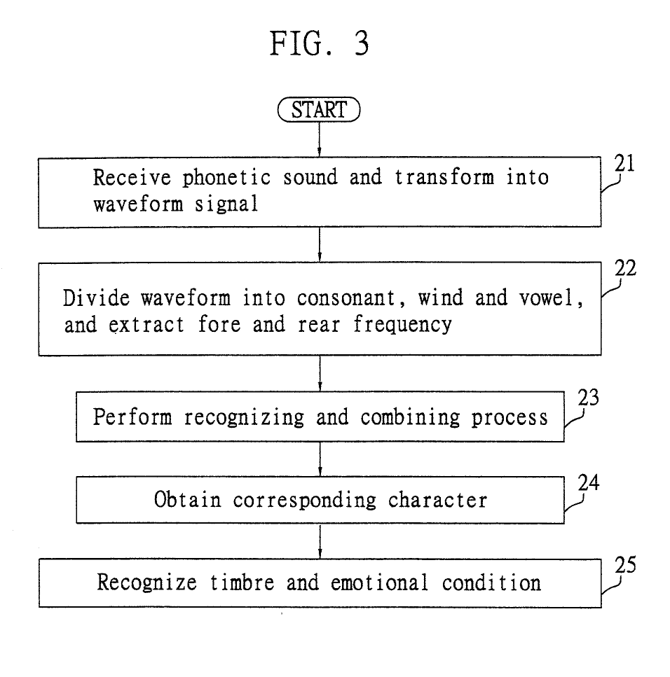

FIG. 3 illustrates the steps involved in performing the method for phonetic recognition so as to recognize a phonetic sound, timbre and emotional condition in the use of the system for phonetic recognition of the invention in FIG. 1. As shown, in step 21, the phonetic transformation processing module 2 receives a phonetic sound from a user and transforms it correspondingly into a physical waveform signal, which is input to the phonetic recognition processing module 4 for phonetic recognition. Then, step 22 is followed.

In step 22, according to principles of phonetic recognition in the phonetic recognition principle database 3, the phonetic recognition processing module 4 processes the input waveform signal from the phonetic transformation processing module 2 by dividing a sound packet of the input waveform signal into parts of consonant, wind and vowel, and extracting its fore frequencies and rear frequencies. Then, step 23 is followed.

In step 23, the phonetic recognition processing module 4 recognizes, processes and combines the parts of consonant, wind and vowel, so as to combine the recognized parts of constant and vowel, or the parts of consonant and vowel and four tone variations. Then, step 24 is followed.

In step 24, the phonetic recognition processing module 4 compares the combinations with the general database of phonetic sounds and corresponding characters 5 so as to obtain a corresponding character for the phonetic sound. Then step 25 is followed.

In step 25, for identifying the timbre of the user, the phonetic recognition processing module 4, according to the principles of phonetic recognition in the phonetic recognition principle database 3, analyzes the sound packet for its carrier wave and edges of modulated saw wave on the carrier wave, so as to obtain the timbre characteristics and differentiate the timbre between users. For recognizing the user's emotional condition, the phonetic recognition processing module 4 analyzes volume variation in the sound packet, which correlates with intonation and reflects the users emotion, according to the principles of phonetic recognition in the phonetic recognition principle 3.

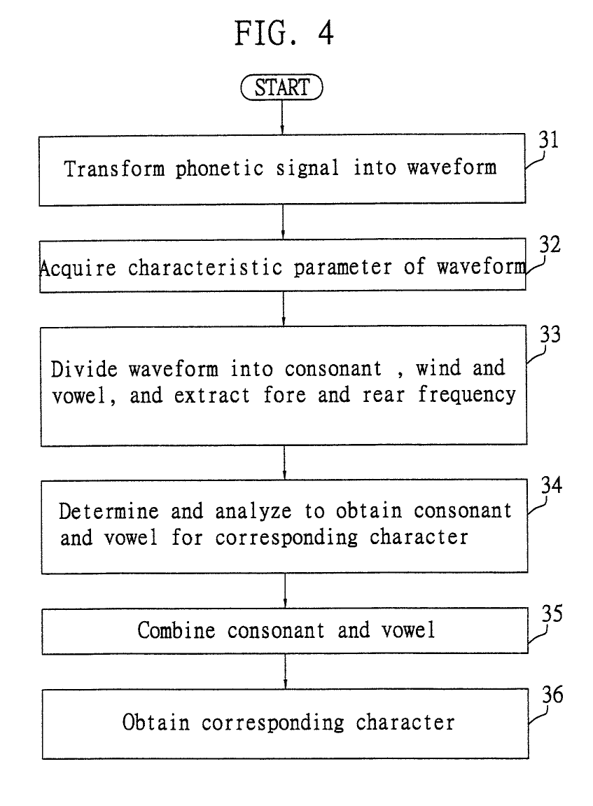

FIG. 4 illustrates the detail steps involved in performing the method for phonetic recognition in the use of the system for phonetic recognition of the invention in FIG. 2. As shown, in step 31, the phonetic transformation processing module 2 receives a phonetic sound from a user and transforms it correspondingly into a physical waveform signal, which is input to the phonetic recognition processing module 4 for phonetic recognition. Then, step 32 is followed.

In step 32, according to principles of phonetic recognition in the phonetic recognition principle database 3, the phonetic recognition processing module 4 analyzes physical characteristics of the waveform signal from the phonetic transformation processing module 2 so as to acquire various characteristic parameters thereof. Then, step 33 is followed.

In step 33, according to various characteristic parameters of the waveform signal, the phonetic recognition processing module 4 processes the waveform signal by dividing a sound packet of the input waveform signal into pans of consonant, wind and vowel, and extracting its fore frequencies and rear frequencies. Then, step 34 is followed.

In step 34, in the use of the principles of phonetic recognition, the phonetic recognition processing module 4 recognizes and analyzes the parts of consonant, wind and vowel according to waveform characteristics of the parts, so as to obtain a character consonant corresponding to the consonant part and a character vowel corresponding to the vowel part. Then, step 35 is followed.

In step 35, the phonetic recognition processing module 4 combines the character consonant and character vowel. Then, step 36 is followed.

In step 36, the phonetic recognition processing module 4 compares the combination of the character consonant and character vowel with the general database of phonetic sounds and corresponding characters 5 so as to obtain a corresponding character for the phonetic sound. Then, the phonetic recognition completes.

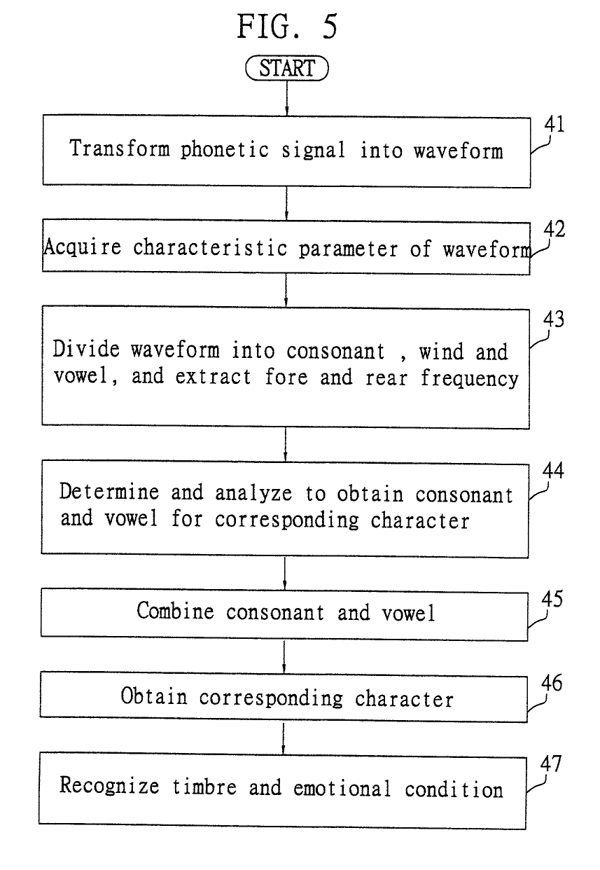

FIG. 5 illustrates the detail steps involved in performing the method for phonetic recognition so as to recognize a phonetic sound, timbre and emotional condition in the use of the system for phonetic recognition of the invention in FIG. 3. As shown, in step 41, the phonetic transformation processing module 2 receives a phonetic sound from a user and transforms it correspondingly into a physical waveform signal, which is input to the phonetic recognition processing module 4 for phonetic recognition. Then, step 42 is followed.

In step 42, according to principles of phonetic recognition in the phonetic recognition principle database 3, the phonetic recognition processing module 4 analyzes physical characteristics of the waveform signal from the phonetic transformation processing module 2 so as to acquire various characteristic parameters thereof. Then, step 43 is followed.

In step 43, according to various characteristic parameters of the waveform signal, the phonetic recognition processing module 4 processes the waveform signal by dividing a sound packet of the input waveform signal into parts of consonant, wind and vowel, and extracting its fore frequencies and rear frequencies. Then, step 44 is followed.

In step 44, in the use of the principles of phonetic recognition, the phonetic recognition processing module 4 recognizes and analyzes the parts of consonant, wind and vowel according to waveform characteristics of the parts, so as to obtain a character consonant corresponding to the consonant part and a character vowel corresponding to the vowel part. Then step 45 is followed.

In step 45, the phonetic recognition processing module 4 combines the character consonant and character vowel. Then, step 46 is followed.

In step 46, the phonetic recognition processing module 4 compares the combination of the character consonant and character vowel with the general database of phonetic sounds and corresponding characters 5 so as to obtain a corresponding character for the phonetic sound. Then, step 47 is followed.

In step 47, for identifying the timbre of the user, the phonetic recognition processing module 4, according to the principles of phonetic recognition in the phonetic recognition principle database 3, analyzes the sound packet for its wave and edges of modulated saw wave on the carrier wave, so as to obtain the timbre characteristics and differentiate the timbre between uses. For recognizing the users emotional condition, the phonetic recognition processing module 4 analyzes volume variation in the sound packet, which correlates with intonation and reflects the user's emotion, according to the principles of phonetic recognition in the phonetic recognition principle database 3. Then, the phonetic recognition completes.

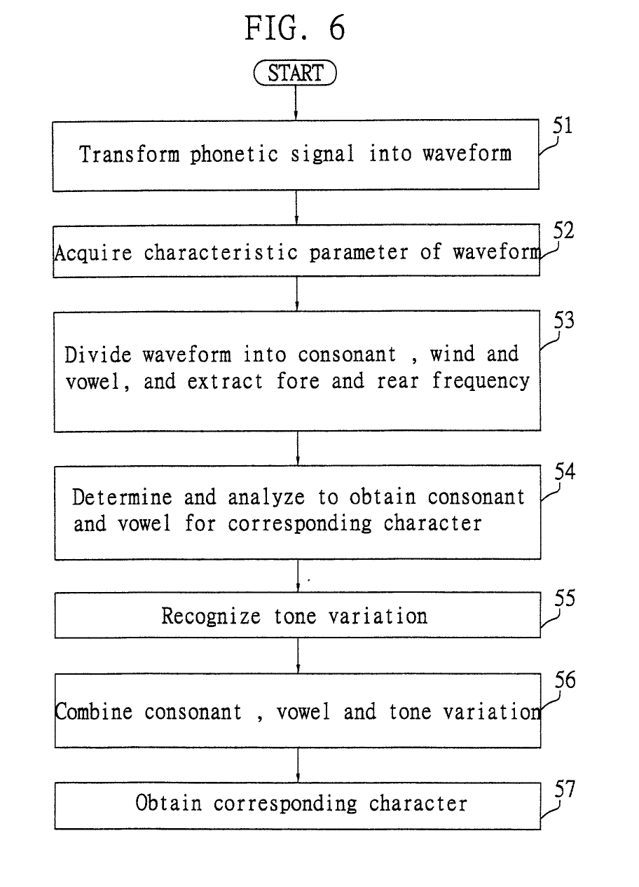

FIG. 6 illustrates the detail steps involved in recognizing a Chinese character correspond to a phonetic in the use of the system for phonetic recognition of the invention in FIG. 4. As shown, in step 51, the phonetic transformation processing module 2 receives a phonetic sound from a user and transforms it correspondingly into a physical waveform signal, which is input to the phonetic recognition processing module 4 for phonetic recognition. Then, step 52 is followed.

In step 52, according to principles of phonetic recognition in the phonetic recognition principle database 3, the phonetic recognition processing module 4 analyzes physical characteristics of the waveform signal from the phonetic transformation processing module 2 so as to acquire various characteristic parameters thereof. Then, step 53 is followed.

In step 53, according to various characteristic parameters of the waveform signal, the phonetic recognition processing module 4 processes the waveform signal by dividing a sound packet of the input waveform signal into parts of consonant, wind and vowel, and extracting its fore frequencies and rear frequencies. Then, step 54 is followed.

In step 54, in the use of the principles of phonetic recognition, the phonetic recognition processing module 4 recognizes and analyzes the parts of consonant, wind and vowel according to waveform characteristics of the parts, so as to obtain a character consonant corresponding to the consonant part and a character vowel corresponding to the vowel part. Then, step 55 is followed.

In step 55, according to principles of phonetic recognition in the phonetic recognition principle database 3, the phonetic recognition processing module 4 extracts fore and rear frequencies of the sound packet. The extracted fore and rear frequencies, together with frequencies of the vowel part and profile variation in waveform amplitude, are used to recognize the variation in four tones for a Chinese phonetic sound. Then, step 56 is followed.

In step 56, the phonetic recognition processing module 4 combines the character consonant, the character vowel and the Chinese tone variation. Then, step 57 is followed.

In step 57, the phonetic recognition processing module 4 compares the combination of the character consonant, character vowel and Chinese tone variation with the gene database of phonetic sounds and corresponding characters 5 so as to obtain a corresponding character for the phonetic sound. Then, the phonetic recognition completes.

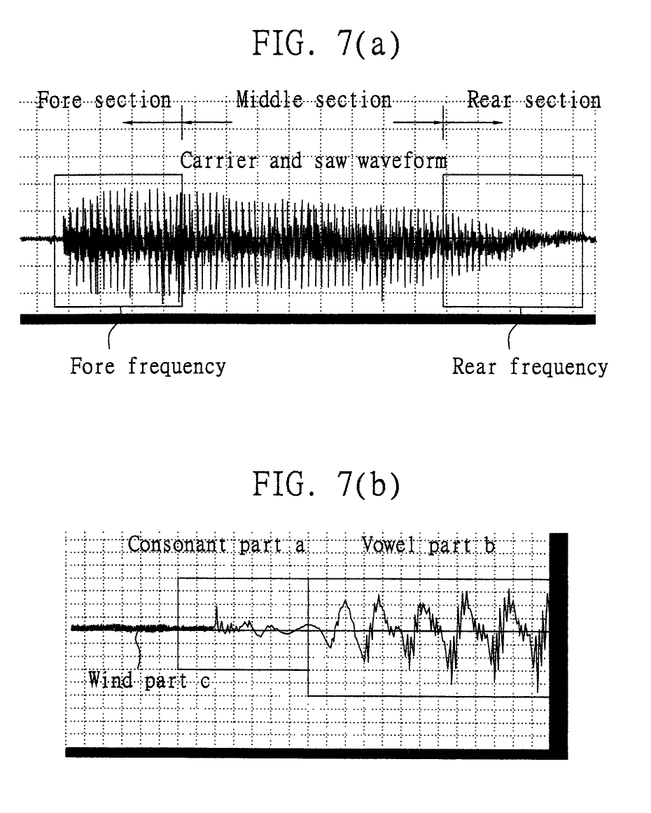

FIG. 7(a) illustrates composition of a phonetic waveform. As shown, a sound packet of the phonetic waveform can be separated into fore, middle and rear sections, wherein wind and consonant portions reside in the fore section and are followed by a vowel portion, while the wind portion is relatively much higher in frequency than the consonant and vowel portions. In the first quarter region of the sound packet of the phonetic waveform, a fore frequency can be obtained by randomly sampling a few sound packets and getting an average frequency thereof. Similarly, in the final quarter region of the sound packet of the phonetic waveform, a rear frequency is obtained by arbitrarily sampling a few sound packets and getting an average frequency thereof. Further in the drawing there are shown a carrier wave of the sound packet of the phonetic waveform and edges of a modulated saw wave on the carrier wave, as well as variation in amplitude volume for the sound packet of the phonetic waveform.

FIG. 7(b) illustrates parts of consonant, wind and vowel. As shown, a general phonetic waveform can be separated into parts of consonant a, wind b and vowel c.

In general, the consonant part a can be classified as a gradation sound, affricate, extrusion sound and plosive according to its waveform. The gradation sound is characterized as being purely composed of the consonant waveform with variation in sound volume, such as Chinese phonetic symbols, “ [symbol] ”, “ [symbol] ”, “ [symbol] ”, “ [symbol] ” (pronounced as “h”, “x”, “r”, “s” respectively). The affricate is characterized as having the consonant waveform with a lingering sound followed by vowel waveform, such as Chinese phonetic symbols, “ [symbol] ”, “ [symbol] ”, “ [symbol] ”, “ [symbol] ”, “ [symbol] ” (pronounced as “m”, “f”, “n”, “l”, “j” respectively), as illustrated in FIG. 7(d). The extrusion sound is a plosive having a slower consonant waveform, such as Chinese phonetic symbols, “ [symbol] ”, “ [symbol] ” (pronounced as “zh”, “z” respectively). The plosive has its consonant waveform containing two or more magnified peaks, such as Chinese phonetic symbols, “ [symbol] ”, “ [symbol] ”, “ [symbol] ”, “ [symbol] ”, “ [symbol] ”, “ [symbol] ”, “ [symbol] ” (pronounced as “b”, “p”, “d”, “t”, “g”, “k”, “q” respectively), as illustrated in FIG. 7(c). The wind part b is much higher in frequency than the consonants and vowels. The vowel part c is a waveform section located right after that for the consonant part.

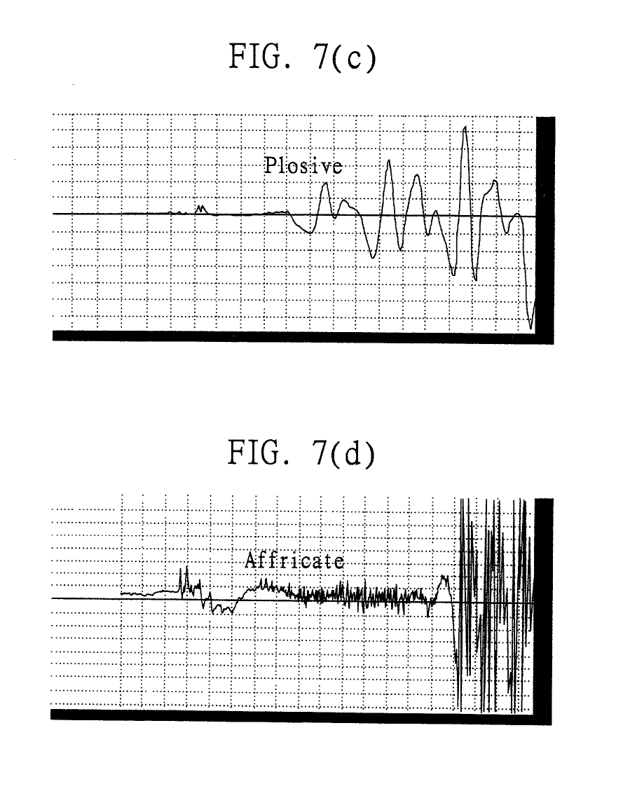

FIG. 8 illustrates composition of the vowel part in FIG. 7(b). As shown, repeated waveform areas in the vowel part c is called vowel packets. The vowel packet 0 is an initial divided sound packet at the beginning of the vowel part c, while the vowel packets 1-3 are divided sound packets showing repetition in vowels. In this case, following vowel packets (e.g. 4) can be observed in a similar way. Herein, the divided sound packets are generated by dividing the vowel waveform into independent vowel packets 0, 1, 2, 3 etc.

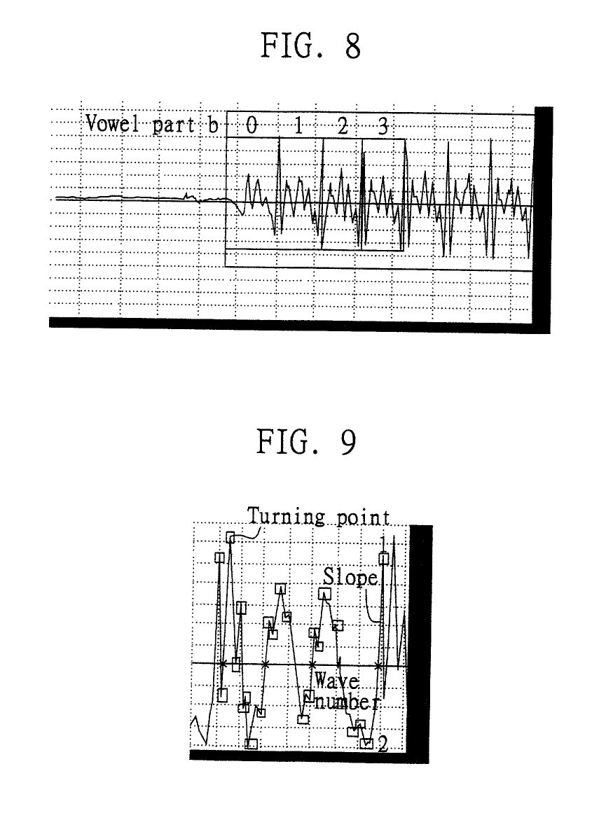

FIG. 9 illustrates characteristic meters of the composition of the vowel part in FIG. 7b). As shown, according to vowel packets formed by dividing the vowel waveform, characteristic parameters, such as turning number, wave number and slope, can be obtained. The turning number is a count of turning points, which each is located at a position within a tiny square in the drawing where the waveform changes the sign of slope. The wave number is a count of times for the waveform of the vowel packet passing through X-axis from a lower domain to an upper domain. For example, in the drawing the wave number is 4 illustrated by 4 points marked as x for showing the waveform passing through the X-axis. The slope can be obtained by measuring the slope or sampling numbers between squares 1 and 2. Subsequently, the above three characteristic parameters can be employed in vowel recognition according to some rules, wherein vowels for Chinese phonetic symbols include “ [symbol] ”, “ [symbol] ”, “ [symbol] ”, “ [symbol] ” and “ [symbol] ” (pronounced as “a”, “o”, “i”, “e” and “u” respectively). For example, if wave number>=slope, the vowel is “ [symbol] ”, otherwise it is “ [symbol] ” or if wave number>=6 and turning number<10, the vowel is “ [symbol] ”, otherwise it is “ [symbol] ”. If turning number>wave number, the vowel is “ [symbol] ”; or if wave number=3 and turning number<13, the vowel is “ [symbol] ”, otherwise it is “ [symbol] ”. If turning number>wave number, the vowel is “ [symbol] ”; or if wave number=4 or 5 and turning number>three times of wave number, the vowel is “ [symbol] ”. If wave number=3 and turning number<6, the vowel is “ [symbol] ”. If wave number=2, the vowel is “ [symbol] ”, otherwise it is “ [symbol] ”; or if wave number=1 and turning number<7, the vowel is “ [symbol] ”, otherwise it is “ [symbol] ”.

For recognizing variation in four Chinese phonetic tones, in the first quarter region of sound packet of the phonetic waveform, a fore frequency can be obtained by randomly sampling a few sound packets and getting an average frequency thereof. Similarly, in the final quarter region of the sound packet of the phonetic waveform, a rear frequency is obtained by arbitrarily sampling a few sound packets and getting an average frequency thereof.

A term “point” in a phrase, “differ by points”, means a number of sampled points and relates to frequency. For example, a sampling frequency of 11 KHz is equivalent to taking one sampled point per 1/11000 second. In other words, 11K sampled points are taken in sampling time of 1 second. Likewise, a sampling frequency of 50 KHz is equivalent to taking one sampled point per 1/50000 second. In other words, 50K sampled points are taken in sampling time of 1 second. That is, in 1 second sampling time, the number of sampled points is identical to the value of frequency.

Once the fore and rear frequencies are obtained, the variation in four Chinese phonetic tones can be identified by the following rules:

1. if the fore and rear frequencies differ by 4 points, the phonetic tone is the first tone of the Chinese phonetic tones;

2. if the fore and rear frequencies differ by 5 points and the fore frequency is higher than the rear one, the phonetic tone is either the first tone or the second tone of the Chinese phonetic tones;

3. if the rear frequency is higher than the fore frequency and a difference in value between the fore and real frequencies is greater than half of the fore frequency, the phonetic tone is the fourth tone of the Chinese phonetic tones; and

4. the third and fourth tone can be determined by using the fore frequency and rear frequencies, if the fore frequency of a phonetic tone for female is smaller than 38 points, the phonetic tone is the fourth tone; if the fore frequency for female is greater than 60 points, the phonetic tone is the third tone; if the fore frequency of a phonetic tone for male is less than 80 points, the phonetic tone is the fourth tone; if the fore frequency is greater than 92 points the phonetic tone is the third tone.

For identifying timbre of a phonetic sound, according to principles of phonetic recognition, the sound packet of the phonetic sound is analyzed for its carrier wave and edges of modulated saw wave on the carrier wave, so as to obtain the timbre characteristics and differentiate the timbre between users according to different carrier wave frequencies and amplitude variations for the phonetic sounds generated by the users.

For recognizing the user's emotional condition, it is analyze and process the sound packet of the phonetic sound for its amplitude, volume variation and intonation, while the volume variation and intonation reflect the user's emotion.

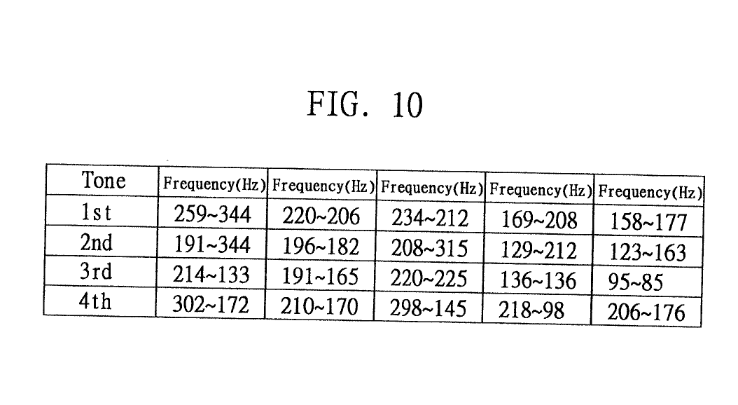

FIG. 10 illustrates statistic frequencies for four tones of Chinese characters. As own in the drawing, a tone of a phonetic sound is the first tone if its frequency is between 259 Hz and 344 Hz. The tone is the second tone if its frequency is between 192 Hz and 196 Hz. The tone is the third tone if its frequency is between 220 Hz and 225 Hz. The tone is the forth tone if its frequency is between 176 Hz and 206 Hz.

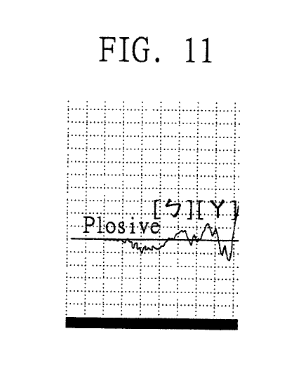

FIG. 11 illustrates a waveform of consonant and vowel for a Chinese character “ [symbol] ” for phonetic recognition. As shown in the drawing, a consonant part is a plosive “ [symbol] ”(pronounced as “b”), while a vowel is “ [symbol] ” (pronounced as “a”) as the wave number is 6, slope is 5 and wave number>slope. So that the consonant and vowel are combined to get a phonetic sound “ [symbol] ” (pronounced as “ba” ) for Chinese character “ [symbol] ”. Further, intonation is inspected for Chinese phonetic tone, so as to distinguish “ [symbol] ”, “ [symbol] ”, “ [symbol] ” and “ [symbol] ”, which represent the phonetic sound “ [symbol] ” having the first, second, third and fourth tone respectively.

In conclusion, the method and system for phonetic recognition of the invention allows phonetic recognition to be implemented by using principles of phonetic recognition and a general database of phonetic sounds and corresponding characters, so as to recognize a phonetic sound generated by a user and identify a character corresponding to the user's phonetic sound, without requiring a personal database of phonetic sounds and corresponding characters for the user to be establish in advance. Moreover, the method and system for phonetic recognition can also recognize a tone of the phonetic sound to be able to identify a Chinese character corresponding in variation of four tones to the phonetic sound. In addition, in the method and system for phonetic recognition, the phonetic sound can be analyzed in timbre characteristic for allowing the user's timbre to be recognized, while variation in volume of the phonetic sound can be analyzed so as to tell the user's emotional condition.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for phonetic recognition, for using principles of phonetic recognition and a general database of phonetic sounds and corresponding characters to conduct phonetic recognition, without requiring a database of personal phonetic sounds and corresponding characters; the method for phonetic recognition comprising the steps of:
(1) processing a phonetic sound generated by a user and transforming the phonetic sound into a phonetic waveform;
(2) dividing a sound packet of the phonetic waveform into different parts;
(3) recognizing the different parts of the sound packet respectively;
(4) combining the recognized parts for determining a character corresponding to the phonetic sound; and
(5) completing the phonetic recognition.

2. The method of claim 1, wherein in the step (2), the sound packet of the phonetic waveform is divided into the parts of consonant, wind and vowel.

3. The method of claim 2, wherein the part of consonant has a waveform of gradation, affricate, extrusion and plosive; the part of vowel has repeated waveform packets, and has characteristic parameters including turning number, wave number and slope, and the part of wind is much higher in frequency than the parts of consonant and vowel.

4. The method claim 3, wherein in the step (3), the part of vowel is processed to divide the repeated waveform packets thereof so as to recognize the parts of consonant and vowel respectively.

5. A method for phonetic recognition, for using principles of phonetic recognition and a general database of phonetic sounds and corresponding characters to conduct phonetic recognition, without requiring a database of personal phonetic sounds and corresponding characters; the method for phonetic recognition comprising the steps of:
(1) processing a phonetic sound generated by a user and transforming the phonetic sound into a phonetic waveform;
(2) analyzing physical properties of the phonetic waveform for acquiring characteristic parameters of the waveform;
(3) dividing a sound packet of the phonetic waveform into parts of consonant, wind and vowel, according to the characteristic parameters;
(4) analyzing the parts of consonant and vowel for waveform characteristics thereof, so as to recognize a character consonant corresponding to the part of consonant and a character vowel corresponding to the part of vowel;
(5) combining the recognized character consonant and character vowel for obtaining a corresponding character, and
(6) completing the phonetic recognition.

6. The method of claim 5, wherein the part of consonant has a waveform of gradation, affricate, extrusion and plosive; the part of vowel has repeated waveform packets, and has characteristic parameters including turning number, wave number and slope; and the part of wind is much higher in frequency than the parts of consonant and vowel.

7. The method of claim 6, wherein in the step (4), the part of vowel is processed to divide the repeated waveform packets thereof, so as to recognize the parts of consonant and vowel respectively.

8. A method for phonetic recognition, for using principles of phonetic recognition and a general database of phonetic sounds and corresponding characters to conduct phonetic recognition, without requiring a database of personal phonetic sounds and corresponding characters; the method for phonetic recognition comprising the steps of:
(1) processing a phonetic sound generated by a user and transforming the phonetic sound into a phonetic waveform;
(2) dividing a sound packet of the phonetic waveform into different parts, and determining a fore frequency and a rear frequency of the sound packet;
(3) recognizing the different parts of the sound packet respectively, and recognizing a tone for the phonetic sound according to a rule for determining the fore and rear frequencies;
(4) combining the recognized parts and the recognized tone for determining a corresponding character for the phonetic sound; and
(5) completing the phonetic recognition.

9. The method of claim 1, wherein in the step (2), the sound packet of the phonetic waveform is divided into the parts of consonant, wind and vowel.

10. The method of claim 9, wherein the part of consonant has a waveform of gradation, affricate, extrusion and plosive; the part of vowel has repeated waveform packets, and has characteristic parameters including turning number, wave number and slope; and the part of wind is much higher in frequency than the parts of consonant and vowel.

11. The method of claim 10, wherein in the step (3), the part of vowel is processed to divide the repeated waveform packets thereof, so as to recognize the parts of consonant and vowel respectively.

12. The method of claim 8, wherein in the step (2), the fore frequency is determined by taking an average frequency for a first quarter region of the sound packet, and the rear frequency is determined by taking an average frequency for a final quarter region of the sound packet.

13. A method for phonetic recognition, for using principles of phonetic recognition and a general database of phonetic sounds and corresponding characters to conduct phonetic recognition, without requiring a database of personal phonic sounds and corresponding characters; the method for phonetic recognition comprising tie steps of:
(1) pressing a phonetic sound generated by a user and transforming the phonetic sound into a phonetic waveform;
(2) analyzing physical properties of the phonetic waveform for acquiring characteristic parameters of the waveform, and determining a fore frequency and a rear frequency of the sound packet,
(3) dividing a sound packet of the phonetic waveform into parts of consonant, wind and vowel, according to the characteristic parameters;
(4) analyzing the parts of consonant and vowel for waveform characteristics thereof, so as to recognize a character consonant corresponding to the part of consonant and a character vowel corresponding to the part of vowel, and recognizing a tone for the phonetic sound according to a rule for determining the fore and rear frequencies;
(5) combining the recognized parts of consonant and vowel and the recognized tone for determining a corresponding character for the phonetic sound; and
(6) completing the phonetic recognition.

14. The method of claim 13, wherein the part of consonant has a waveform of gradation affricate, extrusion and plosive; the part of vowel has repeated waveform packets, and has characteristic parameters including turning number, wave number and slope; and the part of wind is much higher in frequency than the parts of consonant and vowel.

15. The method of claim 14, wherein in the step (4), the part of vowel is processed to divide the repeated waveform packets thereof, so as to recognize the parts of consonant and vowel respectively.

16. The method of claim 13, wherein in the step (2), the fore frequency is determined by taking an average frequency for a first quarter region of the sound packet, and the rear frequency is determined by taking an average frequency for a final quarter region of the sound packet.

17. A system for phonetic recognition, for using principles of phonetic recognition and a general database of phonetic sounds and corresponding characters to conduct phonetic recognition, without requiring a database of personal phonetic sounds and corresponding characters; the system for phonetic recognition comprising:
a phonetic recognition principle database including principles of phonetic recognition to be used for processing a sound packet of a phonetic sound and dividing the sound packet into parts of consonant, wind and vowel, so as to recognize the parts of consonant, wind and vowel respectively, and combine the recognize parts of consonant and vowel to be compared with a database of phonetic sounds and corresponding characters for obtaining a corresponding character for the phonetic sound;
a database of phonetic sounds and corresponding characters, wherein a phonetic sound consists of a consonant and a vowel, and has a corresponding character;
a phonetic transformation processing module for transforming a user's phonetic sound into a corresponding physical waveform signal and inputting the waveform signal to a phonetic recognition processing module for phonetic recognition; and
a phonetic recognition processing module, according to the principles of phonetic recognition in the phonetic recognition principle database, for processing the waveform signal by dividing a sound packet thereof into parts of consonant, wind and vowel, and recognizing the parts respectively, so as to combine the recognized parts of consonant and vowel to be compared with the database of phonetic sounds and corresponding characters for obtaining a corresponding character for the phonetic sound.

18. A system for phonetic recognition, for using principles of phonetic recognition and a general database of phonetic sounds and corresponding characters to conduct phonetic recognition, without requiring a database of personal phonetic sounds and corresponding characters, the system for phonetic recognition comprising:
a phonetic recognition principle database including principles of phonetic recognition to be used for processing a sound packet of a phonetic sound and dividing the sound packet into parts of consonant wind and vowel, and determining a fore frequency and a rear frequency for the sound packet, so as to recognize the parts respectively, recognize a tone for the phonetic sound according to rules for determining the fore and rear frequencies, and combine the recognized parts of consonant and vowel or the recognized parts of consonant and vowel together with the recognized tone to be compared with a database of phonetic sounds and corresponding characters for obtaining a corresponding character for the phonetic sound;
a database of phonetic sounds and corresponding characters, wherein a phonetic sound consists of a consonant and a vowel, or a consonant, a vowel and a tone, and has a corresponding character;
a phonetic transformation processing module for transforming a user's phonetic sound into a corresponding physical waveform signal and inputting the waveform signal to a phonetic recognition processing module for phonetic recognition; and
a phonetic recognition processing module, according to the principles of phonetic recognition in the phonetic recognition principle database, for processing the waveform signal by dividing a sound packet thereof into parts of consonant, wind and vowel, and determining a fore frequency and a rear frequency for the sound packet, so as to recognize the parts respectively, recognize a tone for the phonetic sound according to a rue for determining the fore and rear frequencies, and combine the recognized parts of consonant and vowel or the recognized parts of consonant and vowel together with the recognized tone to be compared with the database of phonetic sounds and corresponding characters for obtaining a corresponding character for the phonetic sound.

19. The system of claim 17, wherein the principles of phonetic recognition in the phonetic recognition principle database include a rule for dividing the sound packet into the parts of consonant, wind and vowel; a rule for recognizing the parts of consonant, wind and vowel; and a rule for combining the recognized parts of consonant and vowel.

20. The system of claim 18, wherein the principles of phonetic recognition in the phonetic recognition principle database include a rule for dividing the sound packet into the parts of consonant, wind and vowel; a rule for determining the fore and rear frequencies; a rule for recognizing the parts of consonant, wind and vowel; a rule for recognizing the tone for the phonetic sound; a rule for combining the recognized parts of consonant and vowel; and a rule for combining the recognized parts of consonant and vowel and the recognized tone.
